(19) United States
(12) Patent Application Publication
(10) Pub. No.: US 2004/0193692 A1
(43) Pub. Date: Sep. 30, 2004

(54) Method of sending an e-mail message

(75) Inventors: Pier Fortunato Bottan, Roma (IT); Francesca Liliana Pasceri, Roma (IT); Cristina Signani, Roma (IT)

Correspondence Address: Jeffrey S. LaBaw, International Business Machines, Intellectual Property Law, 11400 Burnet Road, Austin, TX, 78758, US

(73) Assignee: INTERNATIONAL BUSINESS MACHINES CORPORATION, ARMONK, NY

(21) Appl. No.: 10/798,918

(22) Filed: Mar. 11, 2004

(30) Foreign Application Priority Data
Mar. 27, 2003 (FR) 03368023.2

(51) Int. Cl. G06F 15/16

(52) U.S. Cl. 709/207

(57) ABSTRACT

A method of sending an electronic mail (e-mail) message comprises having a user providing an indication of e-mail addresses of intended message recipients (405-415); based on said indication by the user, a list of destination e-mail addresses (600) is generated (605), and the message is caused to be electronically delivered to each of the e-mail addresses in the list. The user is enabled (420) to provide an indication of at least one excluded e-mail address to be excluded from the list of destination e-mail addresses, and the the list is modified (625, 630) by removing therefrom the at least one excluded e-mail address.

### TECHNICAL FIELD

The present invention generally relates to data processing systems, and particularly to computer networks. More specifically, the present invention relates to e-mail messaging systems.

### BACKGROUND ART

With the growth of computer networks, electronic mail (shortly referred to as e-mail) has become an extremely popular interpersonal communication media, for both private and professional purposes.

Using one of the several e-mail client softwares, such as Lotus Notes, Microsoft Outlook or Outlook Express and Eudora, the composition of an e-mail message is a rather simple task, that involves specifying one or more e-mail addresses of recipients of the message in one or more recipient fields (e.g. the conventional “To”, “Cc” and “Bcc” fields).

In particular, e-mail client softwares include address book utilities that allow creating user-defined address books wherein user-selected e-mail addresses are stored; these utilities also allows the user creating mailing lists or groups of recipients, including two or more e-mail addresses of recipients which the user normally jointly includes in the list of recipients; when the user desires to send an e-mail message to the recipients of a given mailing list, it is not necessary to individually select each recipient from the address book: it sufficies to select the respective mailing list.

It may however happen that the user needs to send an e-mail message only to some of the recipients included in an already existing mailing list, and not to the others: in this case, the mailing list is not useful. The user must either select the indivual recipients, or he/she should create a new recipient group, including only a subset of the recipients of an already existing recipients group. In the first case, the process of composing the e-mail message becomes long and prone to errors: the user may easily forget to add one or more of the recipient addresses, or he/she may erroneously add an undesired address instead of another. The second solution leads to a proliferation of mailing lists in the address book, making the latter bulky and difficult to be consulted.

### SUMMARY OF THE INVENTION

In view of the state of the art outlined above, it has been an object of the present invention to make the process of preparing an e-mail message more efficient.

In particular, it has been an object of the present invention to enable the user to more efficiently handle situations in which a message is to be sent only to a sub-set of recipients within a pre-defined recipient group.

Even more in particular, it has been an object of the present invention to avoid unnecessary proliferation of user-defined groups of recipients.

According to the present invention, we provide a method of sending an electronic mail (e-mail) message, comprising, under the control of a mail user agent:

having a user providing an indication of e-mail addresses of intended message recipients, and

based on said indication by the user, generating a list of destination e-mail addresses, and

causing the message to be electronically delivered to each of the e-mail addresses in the list,

characterised by comprising:

enabling the user providing an indication of at least one excluded e-mail address, and

modifying the list so that the message is not delivered to the at least one excluded e-mail address.

Also according to the present invention we provide a computer program for implementing the above method, when the program is run on a computer.

### BRIEF DESCRIPTION OF THE DRAWINGS

The features and advantages of the present invention will be made apparent by the following detailed description of an embodiment thereof, provided merely by way of non-limitative example, which will be made in conjunction with the attached drawing sheets, wherein:

FIG. 1 is a schematic view of a computer network, implementing a preferred embodiment of the present invention;

FIG. 2 schematically shows the main components of a generic computer of the network;

FIG. 3 schematically shows a partial content of a working memory of a computer of the network while executing an e-mail client software;

FIG. 4 schematically shows a menu page displayed to the computer user for preparing an e-mail message, in an embodiment of the present invention;

FIG. 5 shows a menu page displayed to the computer user for selecting recipient e-mail addresses from a user address book; and

FIG. 6 is a schematic flowchart illustrating a process of generating a recepient list, in an embodiment of the present invention.

### DETAILED DESCRIPTION OF THE PREFERRED EMBODIMENT

With reference to the drawings, in FIG. 1 a distributed data processing system or computer network 100 is schematically shown. The computer network 100 can be for example a local area network (LAN), a metropolitan area network (MAN), a wide area network (WAN) or a network of networks such as the Internet, and comprises a plurality of computers 105a-105f interconnected to each other by means of a data communication infrastructure 110.

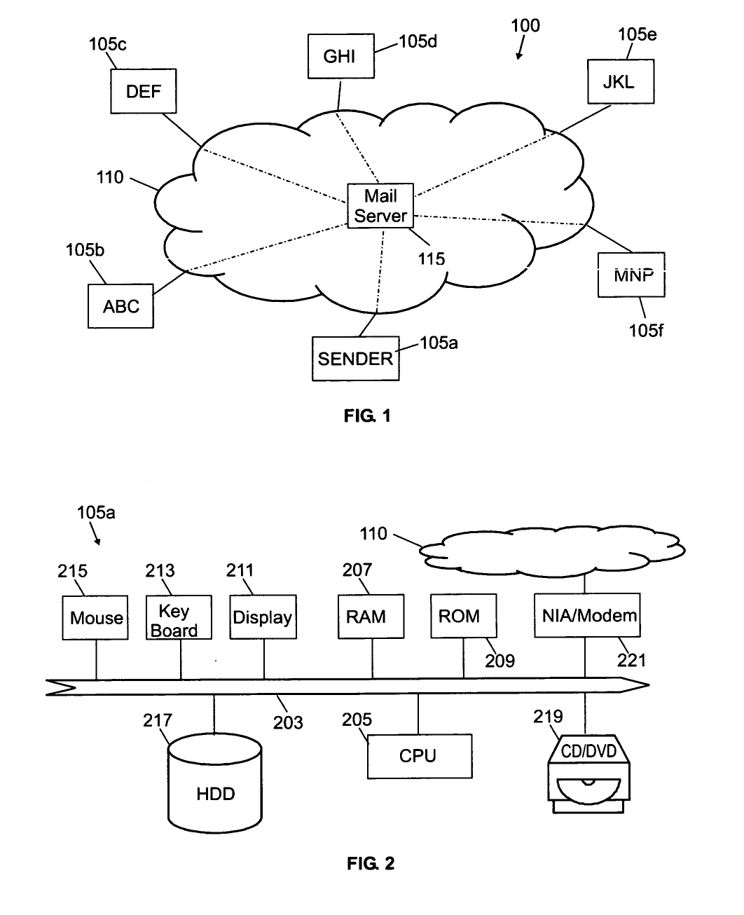

As schematically shown in FIG. 2, a generic computer of the computer network 100, e.g. the computer 105a, comprises several functional units connected in parallel to a data communication bus 203, for example of the PCI type. In particular, a Central Processing Unit (CPU) 205, typically comprising a microprocessor, controls the operation of the computer 105a, a working memory 207, typically a RAM (Random Access Memory) is directly exploited by the CPU 205 for the execution of programs and for temporary storage of data, and a Read Only Memory (ROM) 209 stores a basic program for the bootstrap of the computer 105a. The computer 105a comprises several peripheral units, connected to the bus 203 by means of respective interfaces. Particularly, the peripheral units that allow the interaction with a human user are provided, such as a display device 211 (for example a CRT, an LCD or a plasma monitor), a keyboard 213 and a pointing device 215 (for example a mouse or a trackpoint). The computer 105a also includes peripheral units for local mass-storage of programs (operating system, application programs) and data, such as one or more magnetic Hard-Disk Drivers (HDD), globally indicated as 217, driving magnetic hard disks, and a CD-ROM/DVD driver 219, or a CD-ROM/DVD juke-box, for reading/writing CD-ROMs/DVDs. Other peripheral units may be present, such as a floppy-disk driver for reading/writing floppy disks, a memory card reader for reading/writing memory cards and the like. The computer 105a is further equipped with a Network Interface Adapter (NIA) card 221 for the connection to the data communication network 110; alternatively, the computer 105a may be connected to the data communication network 110 by means of a MODEM.

Any other computer 105b, . . . , 105f in the computer network 100 has a structure generally similar to that depicted in FIG. 2, possibly properly scaled depending on the machine computing performance.

The computer network 100 supports an electronic mail (shortly, e-mail) service, enabling users of the computers 105a-105f to exchange e-mail messages. The details of the e-mail service are known per-se and will not be described in depth. Different e-mail addresses identify different users who are subscriber to the e-mail service; by way of example, in the following it will be assumed that e-mail service is an Internet e-mail service, in which an e-mail address takes the form user@host.domain, and that the users ABC, DEF, GHI, JKL, MNP of the computers 105b to 105f have respective e-mail addresses abc@xy.com, def@xy.com, ghi@zw.com, jkl@zw.com, mnp@qr.net.

One or more computers 115 in the computer network 100 act as e-mail server computers (shortly, mail servers), also known as mail transfer agent, managing the distribution of e-mail messages coming from different users to the intended recipients. When a user desires to take advantage of the e-mail service, he/she has to preliminary subscribe for this service at a mail server; an e-mail account is opened at the mail server for the new subscriber, an e-mail address is assigned thereto, and a mailbox is created. Typically, e-mail messages addressed to a given e-mail address are stored in the mailbox of the mail server holding the corresponding account, until the subscriber user connects to the mail server and downloads the messages from the mailbox. Similarly, when a subscriber user desires to send an e-mail message to one or more other subscribers, he/she composes the e-mail message and sends the message to the respective mail server, which then deliver the message to the recipients, according to the e-mail addresses specified in the message (as will be described later on).

If, for example, the user of a computer 105a (the sender) intends to send an e-mail message to one or more of the users of the computers 105b-105f (the recipients ABC, DEF, GHI, JKL, MNP), the computer 105a sends the message to the respective mail server 115; based on the e-mail addresses of the message recipients, the mail server 115 then delivers the e-mail message to the proper mail servers of the intended recipients. Each mail server holds, for each of the respective subscriber users, a mailbox of incoming e-mail messages; by connecting to the mail server, the user can download the messages in the respective mailbox.

In order to interact with the respective mail server, in each of the computers 105a-105f an e-mail client software is installed. The e-mail client software, when running on a computer, acts as a mail user agent, which interacts with the mail transfer agent. The e-mail client software is invoked whenever the user of the computer desires to send an e-mail message or to connect to the respective mail server, so as to download and display the e-mail messages addressed to him/her.

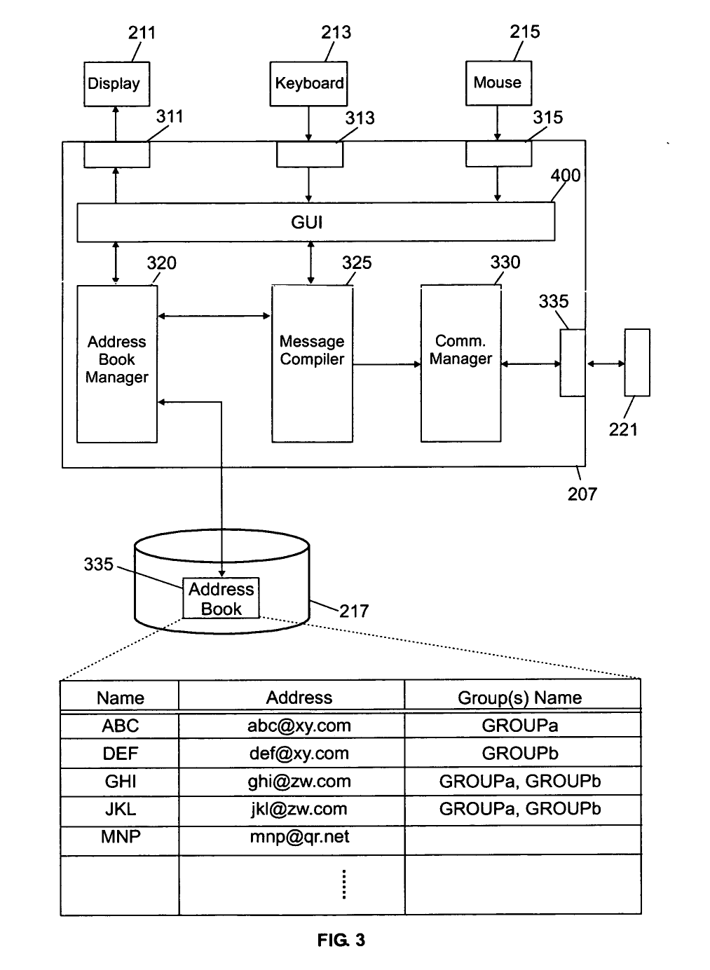

FIG. 3 schematically shows a partial content of a working memory of a generic computer of the network 100, e.g. the computer 105a, during an operation of preparing and sending an e-mail message. A graphical user interface (GUI) 300 allows a friendly interaction of the user with the e-mail client software, through the display device 211 and the input devices 213 and 215; in particular, hardware-dependent software drivers 311, 313 and 315 are exploited by the GUI 300 for communicating with the peripheral devices 211, 213 and 215.

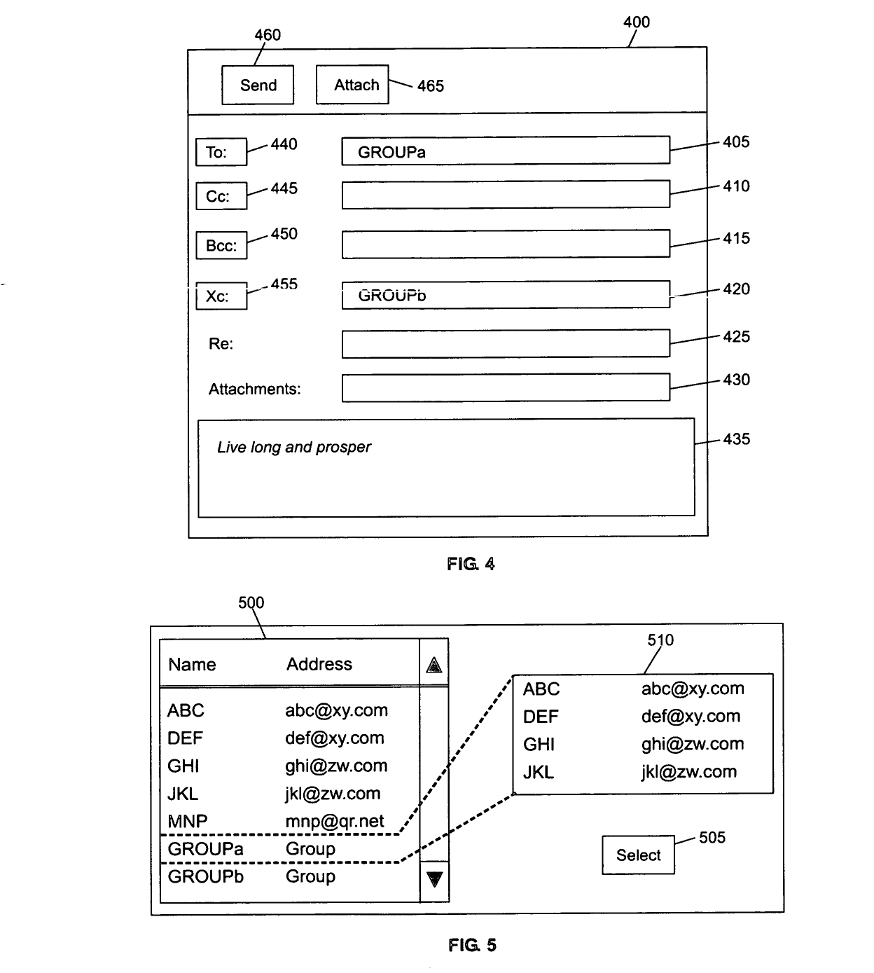

FIG. 4 schematically shows an exemplary menu page 400 that the GUI 300 causes to be displayed to the user on the display device 211 when the user desires to prepare an e-mail message. The menu page 400 includes several fill-in fields 405 to 435 and several buttons 440 to 465. The fields 405 to 420 are used for specifying the intended recipients of the message. The field 425 (“Re” field) allows the user to specify a word or a short phrase indicating the message subject. The field 430 (“Attachments” field) is used to list the files that are optionally attached to the message; the user is normally guided in the selection of the files to be attached by a pop-up menu page (not shown) displayed by clicking on the “Attach” button 465. The field 435 is the message body field, in which the user can write the desired e-mail message text.

Referring back to the fields 405 to 420, the user fills the field 405 (“To” field) to specify the e-mail address or addresses of the intended primary recipients of the message. The field 410 (“Cc” or carbon-copy field) allows the user to specify the e-mail address or addresses of one or more recipients who, albeit not being the intended primary recipients, are intended to receive a (carbon) copy of the message, in addition to the primary recipients. Each of the recipients whose addresses are specified in the “To” or “Cc” fields 405 or 410 are allowed to see, when the message is received and displayed on the respective computer display device, the addresses of all the other recipients whose addresses are specified in the field “To” and “Cc”; on the contrary, the field 415 (“Bcc” or blind carbon-copy field) allows the user specifying one or more e-mail addresses of recipients that are intended to receive the message in copy, without however letting the respective address to be visible by the remaining message recipients. The field 415 thus enables protecting the privacy of the recipients, for example to avoid spamming practices.

The task of introducing in the “To”, “Cc” and “Bcc” fields the e-mail addresses of the intended recipients of the message is made easier by an address book manager utility 320 of the e-mail client software. The address book manager utility 320 allows managing an address book 335, wherein the user can store, for subsequent retrieval, e-mail addresses of desired recipients. In particular, the address book manager utility 320 allows creating personalised recipient groups or lists, each one containing a group of recipients that, according to the user needs, may have to be jointly included in the list of recipients of a message. As schematically shown in FIG. 3, the address book 335 is essentially a file, stored in the computer hard-disk, including a table having as many entries as are the number of recipient e-mail addresses stored therein. Each table entry, substantially a record, includes a “Name” field, in which the name of the recipient is stored, an “Address” field, in which the e-mail address of the recipient is stored, and a “Group(s) Name” field, storing the name or names of the user-defined recipient group or groups in which the recipient is included. In the shown example, the address book 335 includes the addresses abc@xy.com, def@xy.com, ghi@zw.com, jkl@zw.com, mnp@qr.net of the recipients named ABC, DEF, GHI, JKL and MNP; the recipients ABC, DEF, GHI, JKL are supposed to form a first user-defined recipient group named GROUPa, while the recipients GHI, JKL are supposed to form a second user-defined recipient group GROUPb; the recipient MNP is supposed not be included in any recipient group.

In the process of editing the fields 405, 410 and 415 of the menu page 400, the user can invoke the address book manager utility 320 by clicking with the mouse on the buttons 440, 445 and 450 aside the respective field 405, 410 and 415. In this way, the address book 335 is accessed, and a pop-up menu window of the type schematically shown in FIG. 5 is displayed on the screen of the display device. In such a menu window, a list 500 of the names of the recipients and recipient groups present in the address book 335 is displayed; aside each recipient name, the recipient e-mail address is also displayed, while aside the recipient group names only the indication “Group” is for example displayed. The user can pick up the recipients and/or recipient groups from the list by clicking on the respective name in the list, and then clicking on a “Select” button 505; preferably, for the convenience of the user, when the user clicks on the name of a recipient group in the list, the name and addresses of the respective members are displayed in a field 510 of the window.

In this way, the user can fill in any of the fields “To”, “Cc” and “Bcc” of the menu 400. It is however pointed out that nothing prevents the user from manually typing, by means of the keyboard, the desired e-mail address or addresses into one or more of the fields “To”, “Cc” and “Bcc”; preferably, the user is also allowed to enter the name of the recipient or recipient group; the address book manager 320 will then search for the entered name or names in the address book 335 and, if the name is found, associate the entered name with the stored address or addresses.

According to an embodiment of the present invention, the menu pages 400 includes an additional fill-in field 420 (“Xc” or excluded copy field), that allows the user to specify one or more recipients that are to be excluded from the list of recipients of the e-mail message, in the way described in detail later on. The user can fill in the field “Xc” just in the same way as any other field “To”, “Cc” and “Bcc”, by either typing directly the address(es), or the names, or the group name, of the recipients to be excluded, or by invoking the address book manager utility 320.

Through the menu page 400, the user prepares the e-mail message.

When the message has been prepared, the user causes the message to be sent by stricking the “Send” button 460. In this way, a message compiler 325 is invoked. The message compiler 325 gets the data entered by the user through the menu page 400, and prepares a message file, in a prescribed format, to be sent. In particular, the message compiler 325 extracts the information on the message recipients from the fields 405 to 420 of the menu page 400, and generates a message recipient list.

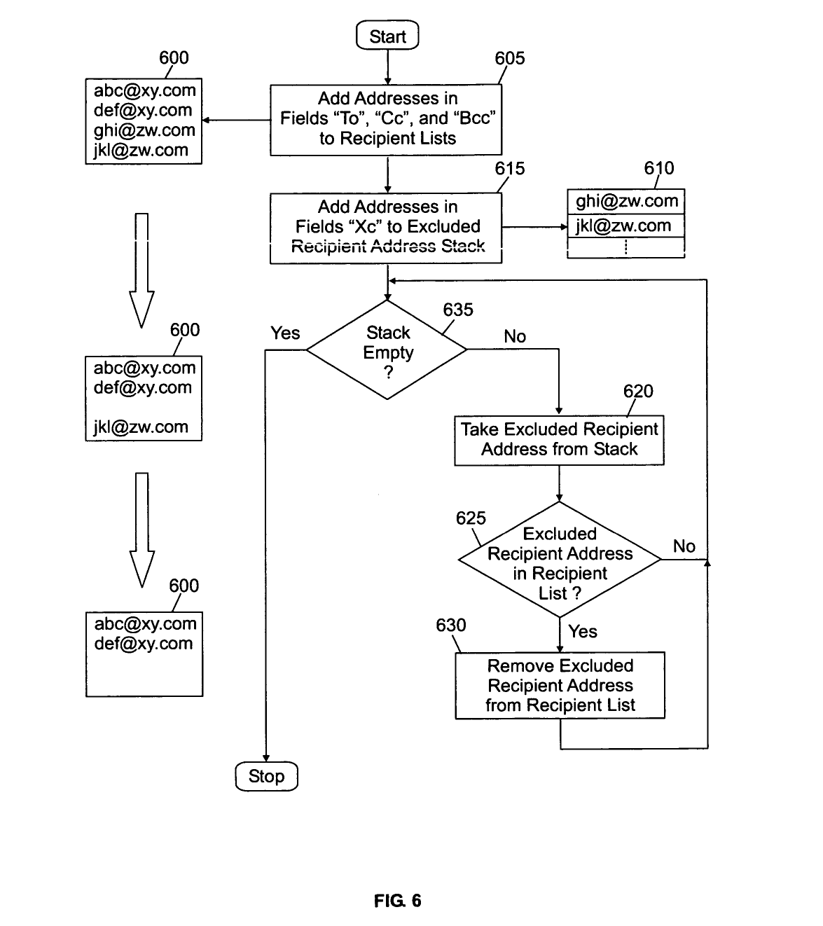

The flowchart of FIG. 6 schematically illustrates the operation of the message compiler 325 as far as the generation of the recipient list is concerned. The message compiler 325 first takes the recipient addresses from the “To”, “Cc” and “Bcc” fields 405, 410 and 415 of the menu page, and adds each of these addresses to a recipient list 600 (block 605). In this process, the message compiler 325 may invoke the address book manager 320, so that a recipient name or a recipient group name are searched for in the address book and the replaced by the corresponding e-mail address or list of addresses; for example, the recipient group name GROUPa introduced by the user in the “To” field 405 is replaced, in the recipient list 600, by the e-mail addresses abc@xy.com, def@xy.com, ghi@zw.com and jkl@zw.com that make up the recipient group GROUPa.

After having built the recipient list 600, the message compiler 325 picks up each of the e-mail addresses possibly specified in the “Xc” field 420, and puts the addresses in a stack 610 of excluded recipient addresses (block 615). It is observed that also in this case the message compiler 325 may invoke the address book manager 320, so as to replace the names of recipients or groups of recipients with the corresponding e-mail addresses.

Referring to the shown example, the stack 610 includes the two exluded recipient addresses ghi@zw.com and jkl@zw.com.

Then, the first excluded recipient address is taken from the stack 610 (block 620); referring to the shown example, the address ghi@zw.com is taken from the stack 610. The recipient list 600 is searched through for ascertaining whether the excluded recipient address is present in the recipient list (block 625). In the affirmative case (block 625, exit branch Y), the excluded recipient address ghi@zw.com is removed from the recipient list (block 630), otherwise, the next address is taken from the stack 610 (block 625, exit branch N). This procedure is repeated until the stack 610 is empty (block 635, exit branch Y).

At the end of this procedure, all the excluded recipient addresses specified (either directly, or in form of recipient names or names of groups of recipients) in the “Xc” field 420 are removed from the recipient list 600 (if present).

After the message compiler 325 has compiled the message file, a communication manager 330 is invoked; the communication manager 330 handles the transmission of the message over the data communication infrastructure 110, by means of the network interface adapter/MODEM 221 (driven by a softare driver 335).

Based on the recipient list in the message, the mail server 115 of the computer 105a sends the message to the intended recipients.

In other words, the provision of the additional “Xc” field 420 enables the user to easily specify e-mail addresses of recipients that are to be excluded from a message recipient list. Clearly, this new, additional feature is useful in the case recipient groups are used to specify recipients in the “To”, “Cc” or “Bcc” fields: in this case, the provision of the “Xc” field enables the user specifying that one or more recipient addresses within the recipient group are to be excluded from the recipient list; without the “Xc” field, the user could not exploit the recipient group, or he/she would have to create a new recipient group, being a subset of an already existing group. Referring to the shown example, without the “Xc” functionality the user should have created a new group made up of the addresses abc@xy.com and def@xy.com, or he/shet should have manually typed these two addresses in the “To” field.

It can be appreciated that thanks to the present invention unnecessary proliferation of recipient groups is avoided, thereby improving the efficiency of address books of e-mail addresses. The present invention also allows reducing the probability of errors committed by the user in the preparation of the message: in fact, the provision of the “Xc” field allows the exploiting already created recipient groups even in situations that, conventionally, would require the user to manually typing all the intended recipient addresses.

1. A method of sending an electronic mail (e-mail) message, comprising, under the control of a mail user agent:
having a user providing an indication of e-mail addresses of intended message recipients, and based on said indication by the user, generating a list of destination e-mail addresses, and
causing the message to be electronically delivered to each of the e-mail addresses in the list, characterised by comprising:
enabling the user providing an indication of at least one excluded e-mail address, and
modifying the list so that the message is not delivered to the at least one excluded e-mail address.

2. The method of claim 1, in which said act of having the user providing an indication of e-mail addresses of intended message recipients includes having the user globally specifying at least one pre-defined group (GROUPa) of e-mail addresses, and said act of generating the list includes putting in the list each of the e-mail addresses of the globally-specified group.

3. The method of claim 1, in which said act of enabling the user to provide an indication of at least one excluded e-mail address includes having the user globally specifying at least one pre-defined group (GROUPb) of e-mail addresses to be excluded, and said act of modifying the list includes removing from the list each of the e-mail addresses of the globally-specified group of e-mail addresses to be excluded.

4. A computer program in a working memory of a computer, for sending an electronic mail (e-mail) message, comprising a mail user agent including means for:
having a user providing an indication of e-mail addresses of intended message recipients and
based on said indication by the user, generating a list of destination e-mail addresses, and
causing the message to be electronically delivered to each of the e-mail addresses in the list, characterised by comprising:
enabling the user providing an indication of at least one excluded e-mail address, and
modifying the list so that the message is not delivered to the at least one excluded e-mail address.

5. A computer program product comprising a computer readable media on which the computer program of claim 4 is stored.

6. A computer programmed to enable a computer user exchanging electronic mail (e-mail) messages with other computer users in a computer network, comprising:
a user-interface software module (300) enabling the user to prepare an e-mail message, the user-interface software module including first input means for enabling the user to provide an indication of e-mail addresses of intended message recipients, and second input means for enabling the user providing an indication of at least one excluded e-mail address to be excluded from the list of destination e-mail addresses; and
a message compiler software module for generating a list of destination e-mail addresses, said list being generated by including all the addresses provided by the user through the first input means, and removing from the list all the addresses provided by the user through the second input means;
a communication manager software module for causing the message to be delivered to each address in the list.

7. The computer of claim 6, further comprising an address book manager software module enabling the user to:
create user-defined groups of prescribed recipient e-mail addresses, and
providing the indication of the e-mail addresses intended message recipients and/or the indication of the at least one excluded e-mail address to be excluded from the list of destination e-mail addresses by globally instantiating a respective user-defined group.
